(19) United States
(12) Patent Application Publication
(10) Pub. No.: US 2010/0021699 A1
(43) Pub. Date: Jan. 28, 2010

(54) DECORATIVE, LOW NOISE LAMINATE EQUIPPED WITH A PATTERNED BALANCE LAYER FORMED BY COMPRESSION

(75) Inventors: Nils-Erik Engstrom, Trelleborg (SE); Carl-Gustav Ek, Trelleborg (SE)

Correspondence Address: NOVAK, DRUCE + QUIGG L.L.P. - PERGO, 1300 Eye Street, N.W., 1000 West Tower, Washington, DC, 20005, US

(73) Assignee: PERGO (EUROPE) AB, Trelleborg (SE)

(21) Appl. No.: 12/304,935

(22) PCT Filed: Jun. 13, 2007
(86) PCT No.: PCT/SE2007/000576

§ 371 Date: Aug. 12, 2009

(30) Foreign Application Priority Data
Jun. 16, 2006 (SE) 0601329-6

(51) Int. Cl. B32B 3/10

(52) U.S. Cl. 428/195.1

(57) ABSTRACT

A decorative laminate, comprising an upper decorative layer and a carrying core. The upper side of the core is provided with the decorative layer and the lower side of the core is provided with a balance layer. The balance layer has the purpose of preventing warping of said decorative laminate and at the same time has the purpose of acoustic dampening. The balance layer comprises a polymer and cellulose said balance layer having a density in the range 30-300 kg/m³. A predetermined area portion of the balance layer is compressed so that the density is increased by a factor of 1.3 or more. Said increased density does not exceed the density 1100 kg/m³. The balance layer thereby forms at least one low density area and at least one high density area.

### BACKGROUND OF THE INVENTION

1. Field of the Invention

The present invention relates to a decorative thermosetting laminate with a damping layer intended to decrease the sound-level.

2. Description of Related Prior Art

Products coated with thermosetting laminate are common nowadays. They are foremost used where the demands on abrasion resistance are great, but also where resistance towards different chemicals and moisture are demanded. As example of such products can be mentioned floors, floor beadings, work tops, desk tops and wall panels.

The thermosetting laminate most often consists of a number of base sheets with decor sheet arranged closest to the surface. The decor sheet can be provided with a desired decor or pattern. Such laminates are very hard in order to withstand the wear they are exposed to. This will unfortunately lead to a high noise level when hard objects are retarded suddenly by the laminate surface, such as hard heels towards a laminate surface.

It is known from prior art to arrange a soft layer below laminate panels. The earliest known art comprised expanded thermoplastic materials which where delivered in rolls and was to be arranged on top of the subfloor before the panels where installed. Also non-woven thermoplastic fabric was used in the same way. It is also known to use these or similar materials glued to the base of the panels. WO 2004/050355 shows an example of such a panel.

It is desirable to be able to muffle the sound level in areas with a floor surface of laminate, specially where shoes normally are used.

### SUMMARY OF THE INVENTION

It has, through the present invention, been made possible to meet the above mentioned desires and a decorative laminate with a lower noise level has been achieved. Accordingly, the invention relates to a decorative laminate comprising an upper decorative layer and a carrying core. The upper side of the core is provided with the decorative layer and that the lower side of the core is provided with a balance layer. The balance layer have the purpose of preventing warping of said decorative laminate and at the same time having the purpose of acoustic dampening. The invention is characterised in that the balance layer comprises a polymer and cellulose and that the balance layer have a density in the range 30-300 kg/m³. A predetermined area portion of the balance layer is compressed so that the density is increased by a factor 1.3 or more. Said increased density does not exceed the density 1100 kg/m³. The balance layer hereby forms at least one low density area and at least one high density area.

According to one embodiment of the invention the decorative laminate is a floor panel. The balance layer have a plurality of areas selected from the group consisting of; low density area in the range 30-300 kg/m3 and high density area in the range, selected low density times 1.3 or more, but no more than 1100 kg/m³.

The plurality of low density area and high density area suitably forms pattern on the balance layer. The low density areas represents at least 50% of the area of the balance layer. The pattern is preferably selected from the group consisting of; parallel lines, triangles, squares, rectangles, hexagons, octagons, circles, random lines or a combination thereof.

According to one embodiment of the invention the balance layer have a thickness of 1.25 mm and density of around 35 kg/m³ in the low density area while the thickness in the high density area is 0.9 mm, while the density is around 45 kg/m³. The high density areas are 1 mm wide, arranged at 5 mm interval so that a square pattern is formed.

The balance layer and the carrying core is preferably joined with each other by means of pressing, whereupon the achieved laminate is cut into panels and provided with edges intended for joining.

According to one embodiment of the invention the decorative layer is constituted by one or more decor papers impregnated with thermosetting resin and one or more overlay sheets impregnated with thermosetting resin arranged on top of the decor papers and possibly one or more thermosetting resin impregnated underlay papers, arranged under the decor paper or decor papers. The papers and sheets are laminated together under increased pressure and increased temperature.

The overlay sheet and the decor paper is suitably impregnated with melamine-formaldehyde resin while the underlay paper is impregnated with phenol-formaldehyde resin.

In order to increase the abrasion resistance at least one of the sheets impregnated with thermosetting resin, preferably the outermost, is suitably provided with hard particles of for example silicon oxide, aluminium oxide and/or silicon carbide with an average size of 1-100 μm, preferably around 5-60 μm.

The thermosetting laminate suitably have a thickness in the range 0.15 mm-1.2 mm, preferably 0.3 mm-0.9 mm and a density in the range 1250-1500 kg/m³.

The carrying core may suitably be constituted by a wood based material like a particle board, a fibre board or an oriented strand board.

According to an alternative embodiment of the invention the carrying core is constituted by a board based on polymers such as polyurethane. Such a carrying core may further comprise fibre or particles.

According to yet another alternative embodiment of the invention the carrying core is constituted by a fibre cement board.

The balance layer preferably have a thickness in the range 0.1-5 mm, most preferably in the range 0.5-3 mm. The balance layer is suitably joined with the carrying core by means of glue and pressure. This glue may be a melt-glue wherein the balance layer is joined with the core by means of heat and pressure.

It is known that polymeric materials, especially under dry conditions, help generate undesired static charges which may cause unpleasant discharges when one touch a metal object like a door handle. This charging may, according to a special embodiment of the invention, be counteracted by having the glue comprising a conductive material. Accordingly, the glue may comprise a conductive material such as carbon black or carbon fibre. This additive is used to an amount so that a conductivity better than 500 kΩcm is achieved.

### DETAILED DESCRIPTION OF AN EMBODIMENT OF THE INVENTION

The invention is further described in connection to enclosed figures showing an embodiment of the invention. The figures does not represent scale drawings and are in someway simplified in order to facilitate understanding of the invention. Accordingly,

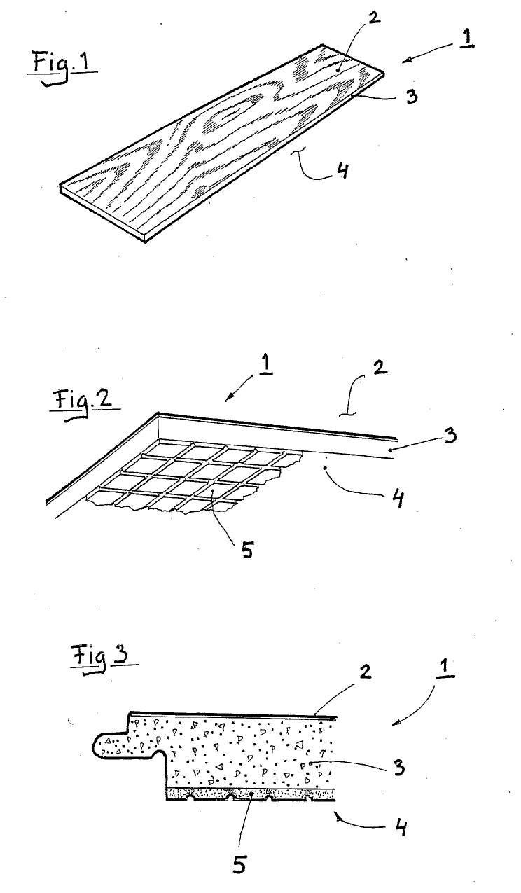

FIG. 1 shows a decorative laminate according to the invention.

FIG. 2 shows a portion of a lower side of a laminate according to the invention.

FIG. 3 shows a cross section of a laminate according to the invention.

FIG. 1-3 shows decorative laminate 1, comprising an upper decorative layer 2 and a carrying core 3. The upper side of the core 3 is provided with the decorative layer 2 and a lower side 4 (see FIGS. 2 and 3) of the core is provided with a balance layer 5 (see FIGS. 2 and 3) having the purpose of preventing warping of said decorative laminate 1 and at the same time having the purpose of acoustic dampening. The balance layer 5 comprises a polymer and cellulose and have a density in the range 30-80 kg/m³. A predetermined area portion of the balance layer 5 is compressed so that the density is increased by a factor around 1.5. The balance layer 5 hereby forms low density areas and high density areas. A plurality of low density areas and high density area grid forms a pattern in the form of squares of low density areas surrounded by narrow high density lines on the balance layer 5.

The configuration with high density areas and low density areas Lade fromn the same material will create a thermocline-like effect where standing waves are dampened as well as hindered from propagating through the material. The term thermocline is best known from oceanographic research where it is known that sonar sometimes is hampered by the fact that seawater can be arranged in layers having different temperatures or salinity. These differences will cause a difference in density and this is what is causing the dampening, reflection and deflection of the sonar waves.

The make up with different density areas will also make the dampening more effective over a larger frequency band.

The balance layer 5 and the carrying core 3 is joined with each other by means of pressing.

The decorative laminate 1 is suitably present in the form of panels provided with edges. These edges are suitably provided with a joint geometry which allows them to be joined, one to the other.

The decorative layer 2 is constituted by one decor paper impregnated with thermosetting resin and one overlay sheet also impregnated with thermosetting resin arranged on top of the decor paper. The papers are laminated together under increased pressure and increased temperature. The overlay sheet and the decor paper are impregnated with melamine-formaldehyde resin. In order to achieve improved abrasion resistance the overlay sheet is provided with small hard particles in the μm range. The thermosetting laminate 1 has a thickness of around 0.15 mm.

The carrying core 3 is constituted by a fibre board having a thickness of around 8 mm while the balance layer has a thickness of around 1 mm.

The invention is not limited by the disclosed embodiments since these can be varied in several ways within the scope of the invention.

1. A decorative laminate, comprising an upper decorative layer and a carrying core, wherein the upper side of the core is provided with the decorative layer and that a lower side of the core is provided with a balance layer, said balance layer having the purpose of preventing warping of said decorative laminate and at the same time having the purpose of acoustic dampening, said balance layer comprising a polymer and cellulose said balance layer having a density in the range 30-300 kg/m³, that a predetermined area portion of the balance layer is compressed so that the density is increased by a factor 1.3 or more, that said increased density does not exceed the density 1100 kg/m³, that the balance layer hereby farms at least one low density area and at least one high density area.

2. The decorative laminate according to claim 1 wherein the decorative laminate is floor panel, that the balance, layer has a plurality of areas selected from the group consisting of a low density area in the range 30-300 kg/m³ and high a density area in the range, selected low density times 1.3 or more, but no more than 1100 kg/m³.

3. A decorative laminate according to claim 1 wherein the balance layer and the carrying core is joined with each other by means of pressing, whereupon the achieved laminate is cut into panels and provided with edges intended for joining.

4. The decorative laminate according to claim 1 wherein the decorative layer is constituted by one or more decor papers impregnated with thermosetting resin and one or more overlay sheets impregnated with thermosetting resin arranged on top of the decor papers and optionally one or more thermosetting resin impregnated underlay papers, arranged under the decor paper or decor papers, which papers are laminated together under increased pressure and increased temperature.

5. A decorative laminate according to claim 4 wherein the overlay sheet and the decor paper is impregnated with melamine-formaldehyde resin.

6. The decorative laminate according to claim 4 wherein the underlay paper is present and is impregnated with phenol-formaldehyde resin.

7. The decorative laminate according to claim 1 wherein the carrying core comprises particle board.

8. The decorative laminate according to claim 1 wherein the carrying core comprises fibre board.

9. The decorative laminate according to claim 1 wherein the carrying core comprises oriented strand board.

10. The decorative laminate according to claim 1 wherein the carrying core comprises a board based on polymers.

11. The decorative laminate according to claim 1 wherein the carrying core comprises fibre cement board.

12. The decorative laminate according to claim 10 wherein the board further comprises fibre.

13. The decorative laminate according to claim 10 wherein the board further comprises particles.

14. The decorative laminate according to claim 4 wherein at least one of the sheets impregnated with thermosetting resin, is provided with hard particles with an average size of 1-100 μm.

15. A decorative laminate according to claim 4 wherein the thermosetting laminate has a thickness in the range 0.15 mm-1.2 mm.

16. A decorative laminate according to claim 4 wherein the thermosetting laminate has a density in the range 1250-1500 kg/m³.

17. The decorative laminate according to claim 1 wherein the balance layer has a thickness in the range 0.1-5 mm.

18. A decorative laminate according to claim 1 wherein the balance layer is joined with the carrying core by means of glue and pressure.

19. The decorative laminate according to claim 18 wherein at least one of the balance layer and the decorative laminate is joined with the carrying core by means of melt-glue, heat and pressure.

20. A decorative laminate according to claim 19 wherein the glue comprises a conductive material.

21. The decorative laminate according to claim 21 wherein the conductive material comprises carbon black.

22. The decorative laminate according to claim 21 wherein the conductive material comprises carbon fibre.

23. A decorative laminate according to claim 20 wherein a conductivity is better than 500 kΩcm.

24. A decorative laminate according to claim 2 wherein the plurality of low density area and high density area forms pattern on the balance layer.

25. A decorative laminate according to claim 2 wherein the low density areas represents at least 50% of the area of the balance layer.

26. The decorative laminate according to claim 24 wherein the pattern is selected from the group consisting of parallel lines, triangles, squares, rectangles, hexagons, octagons, circles, random lines and combinations thereof.

27. The decorative laminate according to claim 14 wherein the thermosetting laminate has a thickness in the range 0.15 mm-1.2 mm.

28. The decorative laminate according to claim 14 wherein the thermosetting laminate has a density in the range 1250-1500 kg/m³.

29. The decorative laminate according to claim 10 when the polymer comprises polyurethane.

30. The decorative laminate of claim 14 wherein the sheet provided with hard particles is the outermost sheet impregnated with thermosetting resin.

31. The decorative laminate of claim 14 wherein the hard particles are at least one selected for the group consisting of silicon oxide, aluminium oxide and silicon carbide.

32. The decorative laminate of claim 14 when the particles have an average particle size of 5-60 μm.
